(19) United States
(12) Patent Application Publication
(10) Pub. No.: US 2024/0188028 A1
(43) Pub. Date: Jun. 6, 2024

(54) METHOD AND DEVICE FOR SUPPORTING TRANSMITTABLE DOWNLINK POSITIONING REFERENCE SIGNAL AS NEEDED IN WIRELESS COMMUNICATION SYSTEM

(71) Applicant: Samsung Electronics Co., Ltd., Suwon-si, Gyeonggi-do (KR)

(72) Inventor: June HWANG, Suwon-si (KR)

(21) Appl. No.: 18/553,165

(22) PCT Filed: Mar. 31, 2022
(86) PCT No.: PCT/KR2022/004599

§ 371 Date: Sep. 28, 2023

(30) Foreign Application Priority Data
Apr. 1, 2021 (KR) 10-2021-0042937
May 13, 2021 (KR) 10-2021-0062164

(51) Int. Cl. H04W 64/00; H04L 5/00; H04W 8/22

(52) U.S. Cl. CPC H04W 64/00; H04L 5/0051; H04W 8/22

(57) ABSTRACT

A method performed by a location management function (LMF) in a wireless communication system, according to an embodiment of the present disclosure, may include obtaining downlink positioning reference signal (DL PRS) configuration information, determining, at least based on the obtained DL PRS configuration information, a need for on-demand DL PRS configuration information, and, in case that it is determined that the on-demand DL PRS configuration information is needed, transmitting the on-demand DL PRS configuration information to a user equipment (UE).

### TECHNICAL FIELD

The present disclosure relates to a wireless communication system, and more particularly, to a method and device for supporting an on-demand downlink (DL) positioning reference signal (PRS) that can be transmitted according a need for positioning.

### BACKGROUND ART

Efforts have been made to develop an improved 5th generation (5G) communication system or pre-5G communication system to keep up with growing wireless data traffic demand after the commercialization of 4th generation (4G) communication systems. For this reason, the 5G or pre-5G communication system is referred to as a beyond 4G network communication system or a post long-term evolution (LTE) system. Implementation of 5G communication systems in an ultra-high frequency (millimeter-wave (mmWave)) band (such as a 60-GHz band) is under consideration to achieve high data transfer rates. To mitigate path loss of radio waves and increase transmission distance of radio waves in an ultra-high frequency band for 5G communication systems, technologies such as beamforming, massive multiple-input multiple-output (MIMO), full dimensional MIMO (FD-MIMO), array antennas, analog beamforming, and large-scale antennas have been studied.

Furthermore, to improve system networks for 5G communication systems, various technologies including evolved small cells, advanced small cells, cloud radio access network (Cloud-RAN), ultra-dense networks, device to device (D2D) communication, wireless backhaul, moving networks, cooperative communication, coordinated multi-points (COMP), and received-interference cancellation have been developed. In addition, for 5G systems, advanced coding modulation (ACM) schemes, such as Hybrid FSK and QAM Modulation (FQAM) and Sliding Window Superposition Coding (SWSC), and advanced access techniques, such as Filter Bank Multicarrier (FBMC), non-orthogonal multiple access (NOMA), sparse code multiple access (SCMA), etc. have been developed.

Moreover, the Internet has evolved from a human-centered connection network, in which humans create and consume information, to the Internet of things (IoT) network in which dispersed components such as objects exchange information with one another to process the information. Internet of Everything (IoE) technology has emerged, in which the IoT technology is combined with, for example, technology for processing big data through connection with a cloud server. To implement the IoT, technologies such as a sensing technology, a wired/wireless communication and network infrastructure, a service interface technology, and a security technology are required, and thus, research has recently been conducted into technologies such as sensor networks for interconnecting objects, machine to machine (M2M) communication, and machine type communication (MTC). In an IoT environment, intelligent Internet technology services may be provided to create new values for human life by collecting and analyzing data obtained from interconnected objects. The IoT may be applied to various fields such as smart homes, smart buildings, smart cities, smart cars or connected cars, a smart grid, healthcare, smart home appliances, advanced medical services, etc., through convergence and integration between existing information technology (IT) and various industries.

Thus, various attempts are being made to apply a 5G communication system to the IoT network. For example, technologies such as sensor networks, M2M communication, MTC, etc., are implemented using 5G communication techniques such as beamforming, MIMO, array antennas, etc. The application of a cloud RAN as the above-described big data processing technology may be an example of convergence between the 5G and IoT technologies.

As various services may be provided as a result of the foregoing and advancements in mobile communication systems, a method of effectively providing these services is required.

### DISCLOSURE

### Technical Problem

Embodiments of the present disclosure provide a method and device for supporting an on-demand downlink (DL) positioning reference signal (PRS) that can be transmitted when needed for positioning.

The present disclosure provides operations of a location management function (LMF) and a user equipment (UE) for using the on-demand DL PRS.

Embodiments of the present disclosure provide an operation in which the LMF can turn on a specific DL PRS that is off and transmit corresponding information to the UE, and the UE performs positioning by using the PRS.

### Technical Solution

A method of configuring a bandwidth in a mobile communication system, according to an embodiment of the present disclosure, may include receiving downlink control information on a downlink control channel, identifying, based on the downlink control information, indication information indicating switching to a dormant bandwidth part (BWP) or switching to an initial active BWP, and switching to the dormant BWP or the initial active BWP based on the indication information.

According to an embodiment of the present disclosure, a method performed by a location management function (LMF) in a wireless communication system may include obtaining downlink positioning reference signal (DL PRS) configuration information, determining, at least based on the obtained DL PRS configuration information, a need for on-demand DL PRS configuration information, and, if it is determined that the on-demand DL PRS configuration information is needed, transmitting the on-demand DL PRS configuration information to a user equipment (UE).

An LMF communicating with a UE in a wireless communication system, according to an embodiment of the present disclosure, may include a transceiver, and a processor operatively coupled to the transceiver and configured to obtain DL PRS configuration information, determine, at least based on the obtained DL PRS configuration information, a need for on-demand DL PRS configuration information, and, if it is determined that the on-demand DL PRS configuration information is needed, transmit the on-demand DL PRS configuration information to the UE.

A method performed by a UE in a wireless communication system, according to an embodiment of the present disclosure, may include receiving DL PRS configuration information from an LMF, transmitting, based on the received DL PRS configuration information, a request for on-demand DL PRS configuration information to the LMF, and receiving the on-demand DL PRS configuration information from the LMF in case that it is determined by the LMF, based on the request for the on-demand DL PRS configuration information and the DL PRS configuration information, that the on-demand DL PRS configuration information is needed.

### Advantageous Effects

According to disclosed embodiments, a transmission and reception point (TRP) of a network may not perform always-on positioning reference signal (PRS) transmission but may perform PRS transmission when needed by a location management function (LMF) or a user equipment (UE), thereby reducing power consumption in network equipment.

### DESCRIPTION OF DRAWINGS

FIG. 1 illustrates a structure of a long-term evolution (LTE) system according to an embodiment of the present disclosure.

FIG. 2 illustrates a radio protocol architecture for an LTE system, according to an embodiment of the present disclosure.

FIG. 3 illustrates a structure of a next-generation mobile communication system according to an embodiment of the present disclosure.

FIG. 4 illustrates a radio protocol architecture for a next-generation mobile communication system, according to an embodiment of the present disclosure.

FIG. 5 is a block diagram of an internal structure of a user equipment (UE) according to an embodiment of the present disclosure.

FIG. 6 is a block diagram of a configuration of a base station according to an embodiment of the present disclosure.

FIG. 7 is a diagram for describing a method, performed by a location management function (LMF), of requesting activation of on-demand DL PRS, according to an embodiment of the present disclosure.

FIG. 8 is a diagram for describing a method of notifying a UE of validity time information when a validity time of activated DL PRS exists, according to an embodiment of the present disclosure.

FIG. 9 is a diagram for describing a method, performed by a UE, of requesting on-demand PRS, according to an embodiment of the present disclosure.

FIG. 10 is a diagram for describing a situation in which an LMF activates on-demand DL PRS according to movement of a UE, according to an embodiment of the present disclosure.

FIG. 11 is a diagram for describing a situation in which a UE in an idle/inactive state requests on-demand PRS when performing measurement, according to an embodiment of the present disclosure.

### MODE FOR INVENTION

Hereinafter, embodiments of the present disclosure will be described in detail with reference to the accompanying drawings.

In the following description of embodiments, descriptions of technical features that are well known in the art to which the present disclosure pertains and are not directly related to the present disclosure are omitted. This is for clearly describing the essence of the present disclosure without obscuring it by omitting the unnecessary descriptions.

For the same reason, in the accompanying drawings, some components are exaggerated, omitted, or schematically illustrated. Furthermore, the size of each element does not entirely reflect an actual size thereof. In the drawings, like reference numerals refer to the same or corresponding elements throughout.

Advantages and features of the present disclosure and methods of accomplishing the same will be more readily appreciated by referring to the following description of embodiments and the accompanying drawings. However, the present disclosure may be embodied in many different forms and should not be construed as being limited to the disclosed embodiments set forth below; rather, the embodiments are provided so that the present disclosure will be thorough and complete and will fully convey the scope of the disclosure to those of ordinary skill in the art, and the present disclosure will only be defined by the appended claims. Throughout the specification, like reference numerals refer to like elements.

It will be understood that each block of a flowchart in the drawings and combinations of blocks of the flowchart may be performed by computer program instructions. These computer program instructions may be loaded into a processor of a general-purpose computer, a special-purpose computer, or other programmable data processing equipment, and thus, the instructions performed via the processor of the computer or other programmable data processing equipment generate a means for performing functions specified in the flowchart block(s). The computer program instructions may also be stored in a computer-executable or computer-readable memory capable of directing a computer or other programmable data processing equipment to implement functions in a specific manner, and thus, the instructions stored in the computer-executable or computer-readable memory may produce an article of manufacture including instruction means for performing the functions described in the flowchart block(s). The computer program instructions may also be loaded into a computer or other programmable data processing equipment, and thus, instructions for operating the computer or the other programmable data processing equipment by generating a computer-executed process when a series of operations are performed in the computer or the other programmable data processing equipment may provide operations for performing the functions described in the flowchart blocks.

Furthermore, each block may represent a portion of a module, segment, or code that includes one or more executable instructions for executing specified logical function(s). It should also be noted that, in some alternative implementations, functions mentioned in blocks may occur out of order. For example, two blocks illustrated in succession may be executed substantially simultaneously, or the blocks may sometimes be executed in reverse order depending on functions corresponding thereto.

As used herein, the term ‘unit’ denotes a software element or a hardware element such as a field-programmable gate array (FPGA) or an application-specific integrated circuit (ASIC), and performs certain functions. However, the term ‘unit’ is not limited to software or hardware. The ‘unit’ may be configured to be in an addressable storage medium or configured to operate one or more processors. Thus, the term ‘unit’ may include, for example, elements such as software elements, object-oriented software elements, class elements, and task elements, processes, functions, attributes, procedures, subroutines, segments of program code, drivers, firmware, micro-codes, circuits, data, a database, data structures, tables, arrays, and variables. Functions provided by the elements and ‘units’ may be combined into the smaller number of elements and ‘units’, or may be further divided into additional elements and ‘units’. Furthermore, the elements and ‘units’ may be embodied to reproduce one or more central processing units (CPUs) in a device or security multimedia card. In addition, in an embodiment, the ‘unit’ may include one or more processors.

In the following description of the present disclosure, when it is determined that detailed descriptions of related known functions or configurations may unnecessarily obscure the subject matter of the present disclosure, the descriptions thereof will be omitted. Hereinafter, embodiments of the present disclosure will be described in detail with reference to the accompanying drawings.

As used in the following description, terms identifying access nodes, terms indicating network entities, terms indicating messages, terms indicating interfaces between network entities, terms indicating various types of identification information, etc. are exemplified for convenience of description. Accordingly, the present disclosure is not limited to terms to be described later, and other terms representing objects having the equivalent technical meaning may be used.

Hereinafter, for convenience of descriptions, the present disclosure uses terms and names defined in the 3rd Generation Partnership Project Long-Term Evolution (3GPP LTE) specifications. However, the present disclosure is not limited to the terms and names but may also be identically applied to systems that comply with other standards. In the present disclosure, for convenience of descriptions, an evolved Node B (eNB) may be used interchangeably with a next-generation Node B (gNB). In other words, a base station described as an eNB may represent a gNB. Furthermore, the term ‘terminal’ may refer to a mobile phone, Narrowband Internet of Things (NB-IOT) devices, sensors, and other wireless communication devices.

Hereinafter, a base station is an entity that allocates resources to a UE, and may be at least one of a gNode B (gNB), an eNode B (eNB), a Node B, a BS, a radio access unit, a base station controller, or a network node. A terminal may include a user equipment (UE), a mobile station (MS), a cellular phone, a smart phone, a computer, or a multimedia system capable of performing a communication function. However, the base station and the terminal are not limited to the above examples.

In particular, the present disclosure may be applied to the 3GPP New Radio (NR) standard (the 5th generation (5G) mobile communications standard). Furthermore, the present disclosure may be applied to intelligent services (e.g., smart homes, smart buildings, smart cities, smart cars or connected cars, health care, digital education, retail businesses, security and safety related services, etc.) based on the 5G communication technology and IoT related technology. In the present disclosure, an eNB may be used interchangeably with a gNB for convenience of descriptions. In other words, a base station described as an eNB may represent a gNB. Furthermore, the term ‘UE’ may refer to a mobile phone, NB-IOT devices, sensors, and other wireless communication devices.

Wireless communication systems have progressed beyond providing initial voice-centered services into broadband wireless communication systems that provide high-speed, high-quality packet data services based on communication standards such as 3GPP's High Speed Packet Access (HSPA), LTE or Evolved Universal Terrestrial Radio Access (E-UTRA), LTE-Advanced (LTE-A), LTE-Pro, 3GPP2's High Rate Packet Data (HRPD), Ultra Mobile Broadband (UMB), and the Institute of Electrical and Electronic Engineers (IEEE) 802.16e.

As a representative example of a broadband wireless communication system, an LTE system adopts an orthogonal frequency division multiplexing (OFDM) scheme for downlink (DL) and a single carrier frequency division multiple access (SC-FDMA) scheme for uplink (UL). UL refers to a radio link through which a UE (or a MS) transmits data or a control signal to a base station (an eNB or a BS), and DL refers to a radio link through which the base station transmits data or a control signal to the UE. In the multiple access schemes as described above, data or control information of each user may be identified by allocating and operating time-frequency resources carrying the data or the control information for each user to prevent overlapping i.e., obtain orthogonality between the time-frequency resources.

Because a post-LTE communication system, i.e., a 5G communication system, needs to be able to freely reflect various requirements from users, service providers, etc., the 5G communication system is required to support services that simultaneously satisfy the various requirements. Services being considered for 5G communication systems include enhanced Mobile BroadBand (eMBB), massive Machine Type Communication (mMTC), Ultra-Reliable Low-Latency Communication (URLLC), etc.

According to some embodiments, eMBB may aim to provide much higher data rates than those supported by legacy LTE, LTE-A, or LTE Pro. For example, in 5G communication systems, eMBB should be able to deliver peak data rates of 20 gigabits per second (Gbps) in DL and 10 Gbps in UL from a base station perspective. Furthermore, the 5G communication systems should be able to provide better user perceived data rates while simultaneously delivering the peak data rates. To meet such requirements, the 5G communication systems may require improvement of various transmission and reception technologies including a further improved multi-input multi-output (MIMO) transmission technology. Furthermore, while a current LTE system transmits signals by using a maximum transmission bandwidth of 20 megahertz (MHz) in the 2 gigahertz (GHz) band, a 5G communication system may satisfy data rates required by a 5G technology by using a wider frequency bandwidth than 20 MHz in the 3 GHz to 6 GHz bands or the bands above 6 GHz.

At the same time, mMTC is being considered to support application services such as the IoT in 5G communication systems. In order to efficiently provide the IoT, the mMTC may require support of massive connections with terminals in a cell, enhanced terminal coverage, improved terminal battery life, low terminal cost, etc. Because the IoT is a system equipped with multiple sensors and various devices to provide communication functions, it must be able to support a large number of terminals (e.g., 1,000,000 terminals per square kilometer (km²)) in a cell. Furthermore, because a terminal supporting the mMTC is highly likely to be located in a shaded area that cannot be covered by a cell, such as a basement of a building, due to characteristics of the service, the mMTC may require wide area coverage compared to other services provided by a 5G communication system. The terminal supporting the mMTC should be configured as a low-cost terminal and may require a very long battery lifetime such as 10 to 15 years because it is difficult to frequently replace a battery of the terminal.

Lastly, URLLC is a cellular-based wireless communication service used for mission-critical applications such as remote control of robots or machinery, industrial automation, unmanned aerial vehicles (UAVs), remote healthcare, emergency alert services, etc. Thus, URLLC communications should be able to provide very low latency (ultra-low latency) and very high reliability (ultra-high reliability). For example, services supporting URLLC need to satisfy air interface latency of less than 0.5 milliseconds (ms) and simultaneously have requirements of packet error rate of 10-5 or less. Thus, for the services supporting URLLC, a 5G system has to provide a transmit time interval (TTI) shorter than for other services and may simultaneously require a design for allocating wide frequency-band resources to ensure high reliability of a communication link.

The above-described three services considered in the 5G communication systems, i.e., eMBB, URLLC, and mMTC, may be multiplexed in one system for transmission of their traffic. In this regard, different transmission and reception techniques and transmission and reception parameters may be used between services to satisfy different requirements for the respective services. However, the mMTC, URLLC, and eMBB are merely examples of different service types, and service types to which the present disclosure is applied are not limited to the above-described examples.

Furthermore, although embodiments of the present disclosure will be described using an LTE, LTE-A, LTE Pro, or 5G (or NR that is next-generation mobile communication) system as an example, the embodiments of the present disclosure may be applied to other communication systems having similar technical backgrounds and channel configurations. It will also be understood by a person skilled in the art that embodiments of the present disclosure are applicable to other communication systems through some modifications not greatly departing from the scope of the present disclosure.

Hereinafter, operation principles of the present disclosure will be described in detail with reference to the accompanying drawings. In the following description of the present disclosure, when it is determined that detailed descriptions of related known functions or configurations may unnecessarily obscure the subject matter of the present disclosure, the descriptions thereof will be omitted. Furthermore, the terms to be described later are defined by taking functions described in the present disclosure into account and may be changed according to a user's or operator's intent or customs. Therefore, the terms should be defined based on the overall descriptions in the present specification.

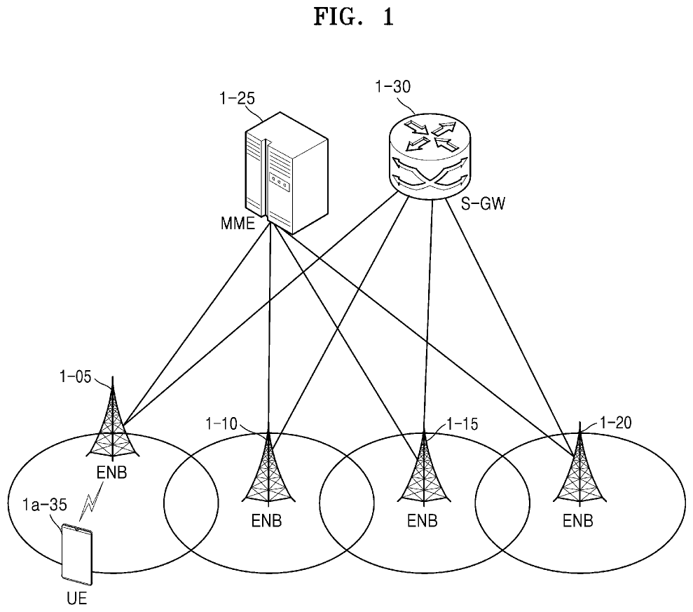

FIG. 1 illustrates a structure of a long-term evolution (LTE) system according to an embodiment of the present disclosure.

Referring to FIG. 1, a radio access network for the LTE system may consist of next-generation base stations (hereinafter referred to as eNBs, Node Bs, or base stations) 1-05, 1-10, 1-15, and 1-20, a mobility management entity (MME) 1-25, and a serving-gateway (S-GW) 1-30. A UE (hereinafter, referred to as a UE or terminal) 1-35 may connect to an external network via the eNBs 1-05 to 1-20 and the S-GW 1-30.

In FIG. 1, the eNBs 1-05 to 1-20 correspond to legacy Node Bs in a universal mobile telecommunication system (UMTS). The eNBs are each connected to the UE 1-35 via radio channels and may perform more complicated functions than the legacy Node B. In the LTE system, all user traffic including real-time services like voice over Internet protocol (VoIP) services may be served on shared channels. Thus, an entity is required to perform scheduling by collecting status information such as buffer states, available transmit power states, and channel states for UEs, and each of the eNBs 1-05 to 1-20 may be responsible for this function. One eNB may generally control multiple cells. For example, to achieve a data rate of 100 megabits per second (Mbps), the LTE system may utilize OFDM as a radio access scheme, e.g., in a 20 MHz bandwidth. Furthermore, the eNBs may apply adaptive modulation & coding (AMC) that determines a modulation scheme and a channel coding rate according to channel states of UEs. The S-GW 1-30 is an entity for providing a data bearer and may create or delete the data bearer according to control by the MME 1-25. The MME is responsible for performing various control functions as well as mobility management for the UE and may be connected to multiple base stations.

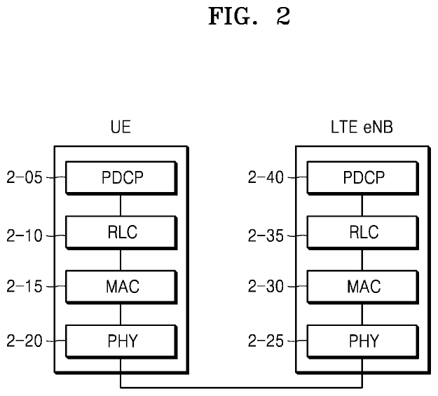

FIG. 2 illustrates a radio protocol architecture for an LTE system, according to an embodiment of the present disclosure.

Referring to FIG. 2, a radio protocol stack for each of a UE and an eNB in the LTE system may consist of packet data convergence protocol (PDCP) 2-05 or 2-40, radio link control (RLC) 2-10 or 2-35, and medium access control (MAC) 2-15 or 2-30. The PDCP may be responsible for operations such as Internet Protocol (IP) header compression/decompression. Main functions of the PDCP may be summarized as follows. The PDCP is not limited to the following example, and may perform various functions.
Header compression and decompression: robust header compression (ROHC) only
Transfer of user data
In-sequence delivery of upper layer packet data units (PDUs) at PDCP re-establishment procedure for RLC acknowledged mode (AM)
Reordering (for split bearers in dual connectivity (DC) (only support for RLC AM): PDCP PDU routing for transmission and PDCP PDU reordering for reception)
Duplicate detection of lower layer service data units (SDUs) at PDCP re-establishment procedure for RLC AM
Retransmission of PDCP SDUs at handover, and, for split bearers in DC, of PDCP PDUs at PDCP data-recovery procedure, for RLC AM
Ciphering and deciphering
Timer-based SDU discard in UL

The RLC 2-10 or 2-35 may reconfigure PDCP PDUs in an appropriate size to perform an automatic repeat request (ARQ) operation, etc. Main functions of the RLC may be summarized as follows. The RLC is not limited to the following example, and may perform various functions.
Data transfer (Transfer of upper layer PDUs)
ARQ (Error correction through ARQ (only for AM data transfer))
   Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected with multiple RLC layers configured in the UE and perform multiplexing of RLC PDUs into MAC PDUs and demultiplexing of RLC PDUs from MAC PDUs. Main functions of the MAC may be summarized as follows. The MAC is not limited to the following example, and may perform various functions.
Mapping between logical channels and transport channels
Multiplexing/demultiplexing of MAC SDUs belonging to one or different logical channels into/from transport blocks (TBs) delivered to/from the physical layer on transport channels
Scheduling information reporting
Hybrid ARQ (HARQ) (Error correction through HARQ)
Priority handling between logical channels of one UE
Priority handling between UEs by means of dynamic scheduling
Multimedia broadcast/multicast service (MBMS) service identification
Transport format selection
Padding

A physical (PHY) layer 2-20 or 2-25 may perform channel coding and modulation on upper-layer data to generate OFDM symbols and transmit the OFDM symbols via a radio channel, or perform demodulation and channel decoding on OFDM symbols received via a radio channel and transfer the demodulated and channel-decoded OFDM symbols to an upper layer. The PHY layer is not limited to the following example, and may perform various functions.

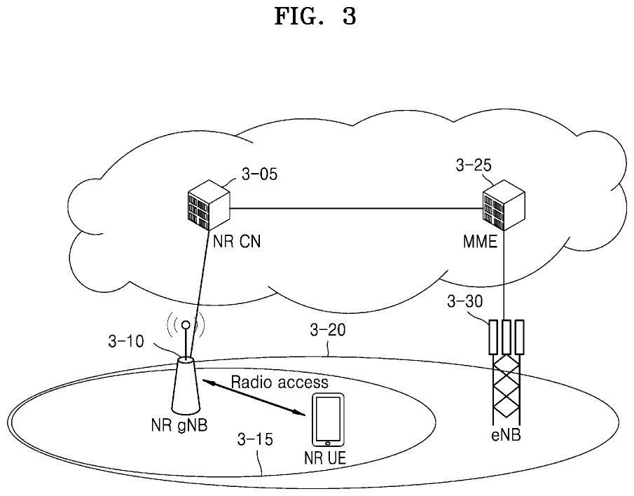

FIG. 3 illustrates a structure of a next-generation mobile communication system according to an embodiment of the present disclosure.

Referring to FIG. 3, a radio access network for the next-generation mobile communication system (hereinafter referred to as NR or 5G system) may consist of an NR Node B (hereinafter referred to as an NR gNB or NR base station) 3-10 and an NR core network (NR CN) 3-05. A next-generation UE (hereinafter referred to as an NR UE or UE) 3-15 may connect to an external network via the NR gNB 3-10 and the NR CN 3-05.

In FIG. 3, the NR gNB 3-10 corresponds to an eNB in the legacy LTE system. The NR gNB may be connected to the NR UE 3-15 via a radio channel and provide a higher level of service than the legacyNode B. In the next-generation mobile communication system, all user traffic may be served on shared channels. Thus, an entity is required to perform scheduling by collecting status information such as buffer states, available transmit power states, and channel states for UEs, and the NR gNB 3-10 may be responsible for this function. One NR NB may generally control multiple cells. The next-generation mobile communication system may have bandwidths greater than the existing maximum bandwidth to achieve ultra-high-speed data transfer as compared to current LTE. Furthermore, the next-generation mobile communication system may additionally apply a beamforming technique using OFDM as a radio access scheme. Furthermore, an AMC scheme may be applied to determine a modulation scheme and a channel coding rate according to a channel state of a UE. The NR CN 3-05 may perform functions such as mobility support, bearer configuration, quality of service (QOS) configuration, etc. The NR CN is an entity responsible for performing various control functions as well as mobility management for a UE and may be connected to multiple base stations. Furthermore, the next-generation mobile communication system may interwork with the legacy LTE system, and the NR CN may be connected with an MME 3-25 via a network interface. The MME may be connected to an eNB 3-30 that is the legacy base station.

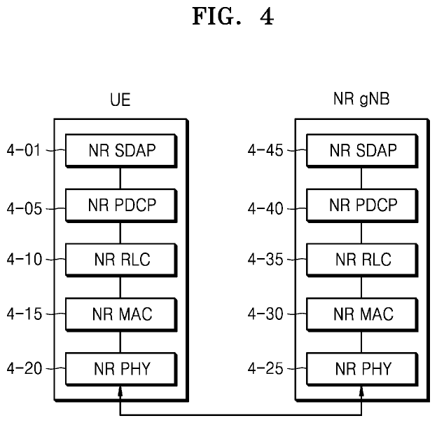

FIG. 4 illustrates a radio protocol architecture for a next-generation mobile communication system, according to an embodiment of the present disclosure.

Referring to FIG. 4, a radio protocol stack for each of a UE and an NR base station in the next-generation mobile communication system includes NR service data adaptation protocol (SDAP) 4-01 or 4-45, NR PDCP 4-05 or 4-40, NR RLC 4-10 or 4-35, NR MAC 4-15 or 4-30, and NR PHY 4-20 or 4-25.

Main functions of the NR SDAP 4-01 or 4-45 may include some of the following functions. The NR SDCP is not limited to the following example, and may perform various functions.
Transfer of user plane data
Mapping between a QoS flow and a data radio bearer (DRB) for both DL and UL
Marking a QoS flow identifier (ID) in both DL and UL packets
Reflective QoS flow to DRB mapping for the UL SDAP PDUs

For a SDAP layer, the UE may receive, via a radio resource control (RRC) message, a configuration as to whether to use a header of the SDAP layer or a function of the SDAP layer per PDCP layer, per bearer, or per logical channel. When an SDAP header is configured, a 1-bit non-access stratum (NAS) reflective QoS indicator and a 1-bit AS reflective QoS indicator in the SDAP header may be used to instruct the UE to update or reconfigure information about mapping between a QoS flow to a DRB for both UL and DL. The SDAP header may include QoS flow ID information identifying QoS. The QoS information may be used as a priority for data processing, scheduling information, etc. to support a smooth service.

Main functions of the NR PDCP 4-05 or 4-40 may include some of the following functions. The NR PDCP is not limited to the following example, and may perform various functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in UL

The reordering function of an NR PDCP entity may refer to a function of sequentially reordering PDCP PDUs received from a lower layer based on a PDCP sequence number (SN). The reordering function of the NR PDCP entity may include a function of transmitting data to an upper layer in an order the data is reordered, a function of directly transmitting data to an upper layer without taking the order into account, a function of reordering PDCP PDUs and recording missing PDCP PDUs, a function of submitting a status report on the missing PDCP PDUs to a transmitting side, and a function of requesting retransmission of the missing PDCP PDUs.

Main functions of the NR RLC 4-10 or 4-35 may include some of the following functions. The NR RLC is not limited to the following example and may perform various functions.
Data transfer (Transfer of upper layer PDUs)
In-sequence delivery of upper layer PDUs
Out-of-sequence delivery of upper layer PDUs
ARQ (Error correction through ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of an NR RLC entity may refer to a function of sequentially transmitting RLC SDUs received from a lower layer to an upper layer. The in-sequence delivery function of the NR RLC entity may include a function of, when one RLC SDU is segmented into multiple RLC SDUs and received, reassembling and transmitting the multiple RLC SDUs.

The in-sequence delivery function of the NR RLC entity may include a function of reordering received RLC PDUs based on an RLC SN or a PDCP SN, a function of reordering RLC PDUs and recording missing RLC PDUs, a function of submitting a status report on the missing RLC PDUs to a transmitting side, and a function of requesting retransmission of the missing RLC PDUs.

The in-sequence delivery function of the NR RLC entity may include a function of sequentially transferring, when there is a missing RLC SDU, only RLC SDUs preceding the missing RLC SDU to an upper layer.

The in-sequence delivery function of the NR RLC entity may include a function of sequentially transferring, to an upper layer, all RLC SDUs received before a given timer is restarted if the timer expires even though there is a missing RLC SDU.

The in-sequence delivery function of the NR RLC entity may include a function of sequentially transferring, to an upper layer, all RLC SDUs received up to a current time point if a given timer expires even though there is a missing RLC SDU.

The NR RLC entity may process RLC PDUs in an order that the RLC PDUs are received regardless of the order of SNs (out-of sequence delivery) and transmit the RLC PDUs to the NR PDCP entity.

When receiving an RLC SDU segment, the NR RLC entity may receive segments stored in a buffer or to be subsequently received to reconstruct a complete RLC PDU and then transmit the RLC PDU to the NR PDCP entity.

The NR RLC layer may not include a concatenation function, and the concatenation function may be performed at the NR MAC layer or be replaced with the multiplexing function of the NR MAC layer.

The out-of-sequence delivery function of the NR RLC entity may refer to a function of directly transmitting RLC SDUs received from a lower layer to an upper layer regardless of their orders. The out-of-sequence delivery function of the NR RLC entity may include a function of, when one RLC SDU is segmented into multiple RLC SDUs and received, reassembling and transmitting the multiple RLC SDUs. The out-of-sequence delivery function of the NR RLC entity may include a function of storing RLC SNs or PDCP SNs of received RLC PDUs and ordering the RLC PDUs and recording missing RLC PDUs.

The NR MAC 4-15 or 4-30 may be connected to multiple NR RLC layers configured in one UE, and main functions of the NR MAC may include some of the following functions. However, the NR MAC is not limited to the following example, and may perform various functions.
Mapping between logical channels and transport channels
Multiplexing/demultiplexing of MAC SDUs
Scheduling information reporting
HARQ (Error correction through HARQ)
Priority handling between logical channels of one UE
Priority handling between UEs by means of dynamic scheduling
MBMS service identification
Transport format selection
Padding

An NR PHY layer 4-20 or 4-25 may perform channel coding and modulation on upper layer data to generate OFDM symbols and transmit the OFDM symbols via a radio channel, or perform demodulation and channel decoding on OFDM symbols received via a radio channel and transfer the demodulated and channel-decoded OFDM symbols to an upper layer. The NR PHY layer is not limited to the above example, and may perform various functions.

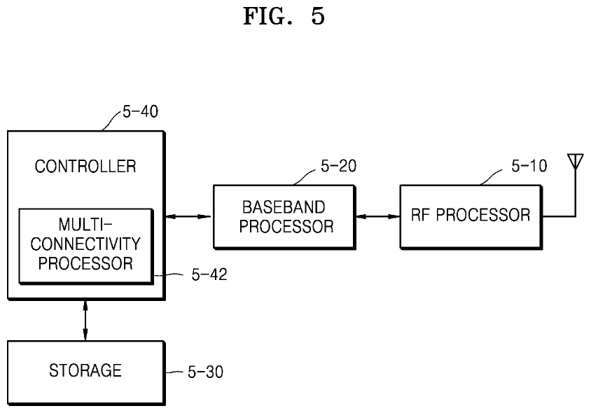

FIG. 5 is a block diagram of an internal structure of a UE according to an embodiment of the present disclosure.

Referring to FIG. 5, the UE may include a radio frequency (RF) processor 5-10, a baseband processor 5-20, a storage 5-30, and a controller 5-40.

The RF processor 5-10 performs functions for transmitting and receiving signals via a radio channel, such as signal conversion between bands and amplification. That is, the RF processor 5-10 may up-convert a baseband signal provided from the baseband processor 5-20 into an RF signal and transmit the RF signal via an antenna, and down-convert an RF signal received via the antenna into a baseband signal. For example, the RF processor 5-10 may include a transmit filter, a receive filter, an amplifier, a mixer, an oscillator, a digital-to-analog converter (DAC), an analog-to-digital converter (ADC), etc. Although only one antenna is illustrated in FIG. 5, the UE may include multiple antennas. The RF processor 5-10 may also include a multiple RF chains. Furthermore, the RF processor 5-10 may perform beamforming. For beamforming, the RF processor 5-10 may adjust a phase and a magnitude of each of the signals transmitted and received through multiple antennas or antenna elements. Also, the RF processor 5-10 may perform MIMO, and receive multiple layers when performing the MIMO operation.

The baseband processor 5-20 may perform a function for conversion between a baseband signal and a bit string according to a physical layer standard of the system. For example, when transmitting data, the baseband processor 5-20 may generate complex symbols by encoding and modulating a transmission bit string. Furthermore, when receiving data, the baseband processor 5-20 may reconstruct a reception bit string by demodulating and decoding a baseband signal from the RF processor 5-10. For example, according to an OFDM scheme, when transmitting data, the baseband processor 5-20 may generate complex symbols by encoding and modulating a transmission bit string, map the complex symbols to subcarriers, and then produce OFDM symbols through inverse fast Fourier transform (IFFT) operations and cyclic prefix (CP) insertion. Furthermore, when receiving data, the baseband processor 5-20 may divide the baseband signal from the RF processor 5-10 into OFDM symbols, recover signals mapped to subcarriers through FFT operations, and then reconstruct a reception bit string through demodulation and decoding.

The baseband processor 5-20 and the RF processor 5-10 transmit and receive signals as described above. Accordingly, the baseband processor 5-20 and the RF processor 5-10 may be referred to as a transmitter, receiver, transceiver, or communication unit. Furthermore, at least one of the baseband processor 5-20 and the RF processor 5-10 may include multiple communication modules to support multiple different radio access technologies (RATs). In addition, at least one of the baseband processor 5-20 and the RF processor 5-10 may include different communication modules to process signals in different frequency bands. For example, the different RATs may include a wireless local area network (WLAN) technology (e.g., IEEE 802.11), a cellular network technology (e.g., LTE), etc. Furthermore, the different frequency bands may include super-high frequency (SHF) bands (e.g., 2.NRHz and NRhz) and millimeter wave (mmWave) bands (e.g., 60 GHZ). The UE may transmit and receive a signal to and from a base station via the baseband processor 5-20 and the RF processor 5-10. In this case, the signal may include control information and data.

The storage 5-30 stores basic programs, application programs, and data such as configuration information for operations of the UE. In particular, the storage 5-30 may store information related to a second access node that performs wireless communication using a second RAT. The storage 5-30 also provides stored data according to a request from the controller 5-40.

The controller 5-40 controls all operations of the UE. For example, the controller 5-40 transmits and receives signals via the baseband processor 5-20 and the RF processor 5-10. The controller 5-40 also writes and reads data to and from the storage 5-30. To achieve this, the controller 5-40 may include at least one processor. For example, the controller 5-40 may include a communication processor (CP) for performing control for communication and an application processor (AP) for controlling upper layers such as application programs.

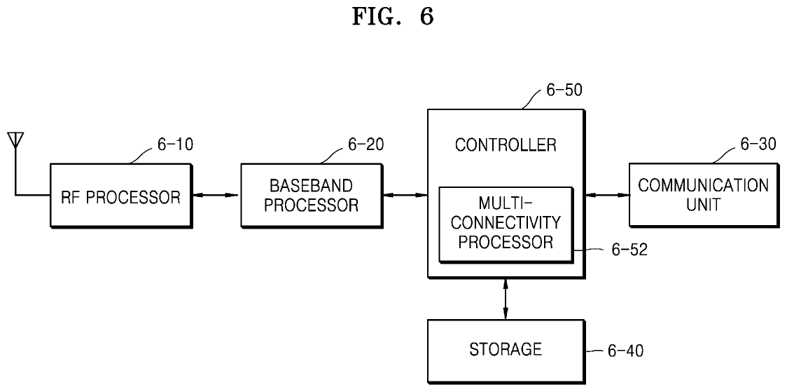

FIG. 6 is a block diagram of a configuration of a base station according to an embodiment of the present disclosure.

Referring to FIG. 6, the base station may include an RF processor 6-10, a baseband processor 6-20, a communication unit 6-30, a storage 6-40, and a controller 6-50.

The RF processor 6-10 performs functions for transmitting and receiving signals via a radio channel, such as signal conversion between bands and amplification. That is, the RF processor 6-10 may up-convert a baseband signal provided from the baseband processor 6-20 into an RF signal and transmit the RF signal via an antenna, and down-convert an RF signal received via the antenna into a baseband signal. For example, the RF processor 6-10 may include a transmit filter, a receive filter, an amplifier, a mixer, an oscillator, a DAC, an ADC, etc. Although only one antenna is illustrated in FIG. 6, the base station may include multiple antennas. The RF processor 6-10 may also include multiple RF chains. Furthermore, the RF processor 6-10 may perform beamforming. For beamforming, the RF processor 6-10 may adjust a phase and a magnitude of each of the signals transmitted and received through multiple antennas or antenna elements. The RF processor 6-10 may perform an MIMO DL operation by transmitting one or more layers.

The baseband processor 6-20 may perform a function for conversion between a baseband signal and a bit string according to a physical layer standard of a RAT. For example, when transmitting data, the baseband processor 6-20 may generate complex symbols by encoding and modulating a transmission bit string. Furthermore, when receiving data, the baseband processor 6-20 may reconstruct a reception bit string by demodulating and decoding a baseband signal from the RF processor 6-10. For example, according to an OFDM scheme, when transmitting data, the baseband processor 6-20 may generate complex symbols by encoding and modulating a transmission bit string, map the complex symbols to subcarriers, and then produce OFDM symbols through IFFT operations and CP insertion. Furthermore, when receiving data, the baseband processor 6-20 may divide the baseband signal from the RF processor 6-10 into OFDM symbols, recover signals mapped to subcarriers through FFT operations, and then reconstruct a reception bit string through demodulation and decoding. The baseband processor 6-20 and the RF processor 6-10 may transmit and receive signals as described above. Accordingly, the baseband processor 6-20 and the RF processor 6-10 may be referred to as a transmitter, receiver, transceiver, or communication unit. The base station may transmit and receive a signal to and from a UE via the baseband processor 6-20 and the RF processor 6-10. In this case, the signal may include control information and data.

The communication unit 6-30 provides an interface to communicate with other nodes in a network. That is, the communication unit 6-30 converts a bit string to be transmitted from a primary base station to another node, such as an auxiliary base station, a CN, or the like, into a physical signal, and converts a physical signal received from the other node into a bit string.

The storage 6-40 stores basic programs, application programs, and data such as configuration information for operations of the primary base station. In particular, the storage 6-40 may store information about bearers allocated to a connected UE, measurement results reported by the connected UE, etc. Furthermore, the storage 6-40 may store information that is a criterion for determining whether to provide or terminate multiple connectivity to or from the UE. The storage 6-40 also provides stored data according to a request from the controller 6-50.

The controller 6-50 controls all operations of the primary base station. For example, the controller 6-50 transmits and receives signals through the baseband processor 6-20 and the RF processor 6-10 or through the backhaul communication unit 6-30. The controller 6-50 also writes and reads data to and from the storage 6-40. To achieve this, the controller 6-50 may include at least one processor.

In using on-demand DL positioning reference signal (PRS) in the present disclosure, a related procedure may be initiated by a location management function (LMF) or a UE.

In an embodiment, if the LMF initiates a procedure related to the use of on-demand DL PRS, the procedure may be performed as follows.

The LMF may request activation of on-demand DL PRS from a transmission and reception point (TRP) or a base station (e.g., gNB).

The LMF that has received a location request (Mobile Originated Location Request (MO-LR)) from the UE or a Mobile Terminated Location Request (MT-LR) from an external entity or access and mobility management function (AMF) may transmit a request for a specific unit of PRS transmission to a particular TRP by determining an operation status of DL PRS at a TRP with which the LMF is currently involved. Such a request for PRS transmission may be transmitted via an NR Positioning Protocol A (NRPPa) message or a separate field in a legacy message. The following information may be included in a PRS transmission request message.
An indicator indicating a request for on-demand PRS
An indicator indicating which positioning method to use (meaning a positioning method)
Information on a specific cell/TRP, information on a specific frequency, information on a preferred or requested beam, resource information, and combinations of these pieces of information.

For example, the above information may be cell physical cell ID (PCI)/cell global ID (CGI) information, a TRP ID (or absolute radio frequency channel number (ARFCN) or frequency layer index (FLI) and PCI information associated with each cell or TRP), NR ARFCN information, a DL PRS resource set ID, a DL PRS resource ID, PCI/CGI information of a specific reference cell and specific synchronization signal block (SSB) index information of the cell, and information on PRS resources (combination of a set ID and a resource ID) having a quasi co-location (QCL) relationship with the corresponding SSB, or specific beam index information used in radio resource management (RRM).

In this case, if the specific SSB index information of the specific reference cell is transmitted to the TRP via the above message, the TRP may determine that the SSB index information indicates a PRS resource that are using the corresponding SSB index as a QCL source among TRP resources that the TRP can operate.
DL PRS transmission power request information or specific power request information from a reception perspective
Information on time for which activation is required
Requested subcarrier spacing (SCS) information

Upon receiving the request for PRS transmission, the TRP may start transmission of the requested DL PRS and transmit a result to the LMF in response to the request for PRS transmission. This response may be transmitted via a NRPPa message or a separate field in a legacy message. The response message may include information about an activated DL PRS. Information about the activated DL PRS may include the following information.
Information on an activated specific cell/TRP, information on an activated specific frequency, information on an activated beam, information on an activated resource, and combinations of these pieces of information.

For example, the above information may be cell PCI/CGI information, a TRP ID (or ARFCN and PCI information), NR ARFCN information, a DL PRS resource set ID, a DL PRS resource ID, PCI/CGI information of a specific reference cell and specific SSB index information of the cell, and information on all PRS resources (combination of a set ID and a resource ID) having a QCL relationship with the corresponding SSB, or specific beam index information used in RRM.
DL PRS transmission power
Information on time for which activation lasts
SCS information

Upon receiving the response, the LMF may transmit, to the UE, final selected DL PRS configuration information, i.e., final activated DL PRS configuration information. This final selected DL PRS configuration information may be transmitted via a separate field in a LTE Positioning Protocol (LPP) Assistance Information message or a separate LPP message. In this case, the final selected DL PRS configuration information delivered to the UE may include the following.
Information on an activated specific cell/TRP, information on an activated specific frequency, information on an activated beam, and information on an activated resource, and combinations of these pieces of information.

For example, the above information may be cell PCI/CGI information, a TRP ID (or ARFCN and PCI information), NR ARFCN information, a DL PRS resource set ID, a DL PRS resource ID, PCI/CGI information of a specific referece cell and specific SSB index information of the cell, and information on all PRS resources (combination of a set ID and a resource ID) having a QCL relationship with the corresponding SSB, or specific beam index information used in RRM.
DL PRS transmission power
Information on time for which activation lasts
SCS information

The UE performs measurement and position estimation based on the final selected DL PRS configuration information. That is, measurement and position estimation may be performed using a DL PRS indicated by the final selected DL PRS configuration information.

If necessary, the UE may deliver a measurement result to the LMF.

In an embodiment, validity time information of DL PRS may be processed as follows.

OPTION 1 The DL PRS activated by the TRP may only be valid for a specific time. If information about the specific time is transmitted to the LMF via a NRPPa message included in an activation response message, the LMF may deliver validity time information to the UE in assistance data for the on-demand DL PRS. A validity time value given in the response from the TRP is not always the same, and the LMF may define the validity time value as a different value by considering signaling latency and transmit it to the UE as a timer value. In this case, the UE may recognize that the DL PRS is valid for the corresponding time, perform continuous measurements, and transmit measurement information to the LMF.

OPTION 2 The TRP may perform DL PRS deactivation and transmit a related message to the LMF without delivering separate time information to the LMF or the UE. Because the deactivated DL PRS is no longer valid, the LMF may include the updated DL PRS configuration information in assistance information, except for information related to the deactivated DL PRS, and transmit it to the UE. The UE may perform measurements based on the latest assistance information.

In an embodiment, the UE may initiate a procedure related to the use of on-demand DL PRS. The UE may request on-demand DL PRS transmission (activation or turning-on) when the UE determines that assistance information provided to it is insufficient and/or when the UE receives, from the LMF, an indicator indicating that an on-demand DL PRS request is possible via a Provide Assistance Data message. In another case, the UE may request on-demand DL PRS transmission only based on the UE's determination without an indicator indicating that an on-demand DL PRS request is possible in the Provide Assistance Data from the LMF. In this case, the UE may transmit the following information to the LMF in a Request Assistance Data message.
An indicator indicating a request for on-demand PRS
An indicator indicating which positioning method is desired to be used (meaning a positioning method)
Information on a specific cell/TRP, information on a specific frequency, beam preference or request information, resource information, and combinations of these pieces of information.

For example, the above information may be cell PCI/CGI information, a TRP ID (or ARFCN or FLI and PCI information), NR ARFCN information, a DL PRS resource set ID, a DL PRS resource ID, PCI/CGI information of a specific referece cell and specific SSB index information of the cell, and information on all PRS resources (combination of a set ID and a resource ID) having a QCL relationship with the corresponding SSB, or specific beam index information used in RRM.

In this case, if specific SSB index or beam ID information of the specific reference cell is transmitted to the LMF, the LMF may determine that DL PRSs requested by the UE are DL PRSs that are using a specific SSB for the corresponding cell as a QCL source, or DL PRSs transmitted on a specific beam of the cell. Later, when requesting on-demand DL PRS activation from the TRP via an NRPPa message, the LMF may request the TRP to activate, among TRP resources that the TRP can operate, a DL PRS resource using the corresponding SSB index as a QCL source or a DL PRS resource using a beam having the same ID as the corresponding beam.
DL PRS transmission power request information or specific power request information from a reception perspective
Information on time for which activation is required
Requested SCS information

In an embodiment, when the UE wants to request on-demand DL PRS transmission from the LMF, the UE may transmit, to the LMF, information about expected reliability, accuracy, QoS, or the like of a measurement result provided by the UE. In an embodiment, information about reliability, accuracy, or QoS may include, for example, a Boolean value indicating that the reliability, accuracy, or QoS of a measurement result is ‘expected to be high’ or ‘expected to be poor’. Furthermore, information about QoS may include a Boolean value indicating whether QoS required during measurement is satisfied. In addition, the information about QoS may also include a Boolean value indicating that a received signal strength of DL PRS currently or previously measured is ‘good’ or ‘bad’. In addition, the information about QoS may include an indicator requesting additional DL PRS transmission.

In an embodiment, when the UE requests on-demand DL PRS transmission from the LMF with or without the above-described information, the UE may transmit the number of beams additionally required for its measurement and/or the number of TRPs additionally required for the measurement in the corresponding message. In this case, the number of beams and/or the number of TRPs may be expressed as an integer value.

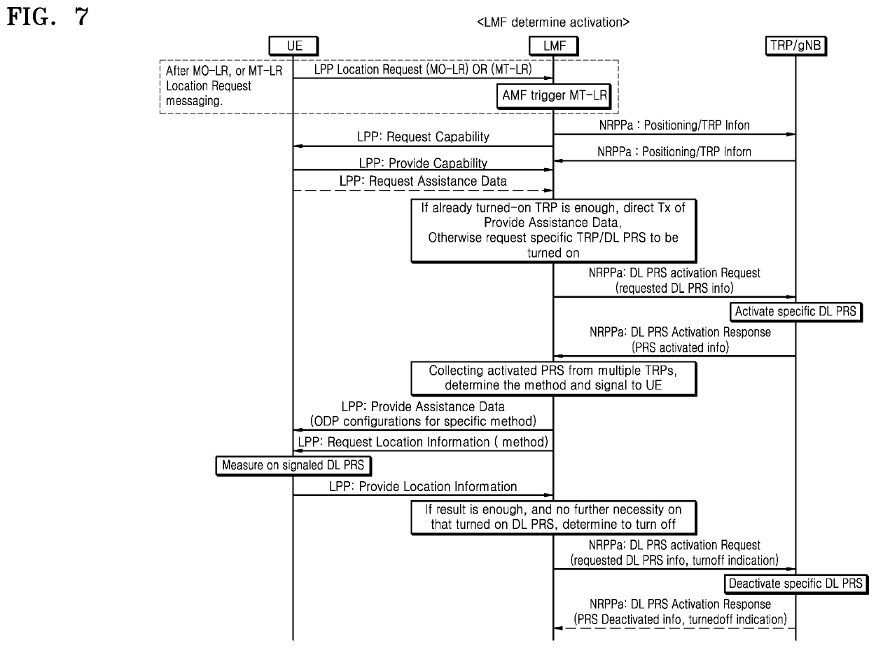

FIG. 7 is a diagram for describing a method, performed by an LMF, of requesting activation of on-demand DL PRS, according to an embodiment of the present disclosure.

The LMF may receive a location request (LR)(MO-LR or MT-LR) from a UE or AMF. Upon receiving the LR, the LMF may perform a positioning operation. Before or after receiving the LR, the LMF may obtain PRS transmission information of each TRP from TRPs existing within its own area or from base stations, e.g., gNBs, serving TRPs, and may be aware of whether each DL PRS is currently being transmitted.

As such, among NRPPa messages used for requesting PRS transmission, an NRPPa Positioning/TRP Information Request message may include an indicator used by the LMF to check whether DL PRS from a corresponding TRP can be turned on or off, an indicator for determining at what level DL PRS can be turned on/off, etc. In addition, an NRPPa Positioning/TRP Information Response message as a response corresponding to the NRPPa Positioning/TRP Information Request message may include an indicator indicating whether DL PRS from the TRP can be turned on/off, an indicator indicating at what level DL PRS can be turned on/off, etc. The indicator indicating a level may specify a resource unit and deliver the related information. For example, the indicator indicating a level may include an indicator indicating a resource level or a resource set level, a frequency level, a cell level, a TRP level, etc.

The LMF that has received the response to the NRPPa Positioning/TRP Information Request from the TRP may indicate DL PRS in resource units indicated as available when later requesting on-demand DL PRS transmission from a specific TRP.

The LMF may request capability information from the UE that has transmitted the LR, receive a response thereto, and store the capability information of the UE. If the LMF determines, based on the PRS transmission information of each TRP and the capability information of the UE, that pieces of information about currently activated DL PRSs are sufficient to measure a location of the UE, the LMF may immediately transmit the pieces of information about DL PRSs that are currently in use to the UE via the LPP Provide Assistance Data. In an embodiment, the LMF may determine whether pieces of information about currently activated DL PRSs are sufficient to measure the location of the UE, based on the number of the currently activated DL PRSs, a relative location, transmission power, etc. If the LMF determines that the current DL PRS information is not sufficient and there is a TRP additionally available for activation, the LMF may request additional activation of DL PRS from the TRP via an NRPPa message.

In this process, a DL PRS Activation Request message that is the NRPPa message may be used. The DL PRS Activation Request message may include the aforementioned pieces of information related to a PRS whose activation is to be requested, such as cell, frequency, resource set, resource, beam, etc. Upon receiving the DL PRS Activation Request message, the TRP may activate the PRS by considering the requested PRS resources. The TRP may finally transmit information about the PRS activated by the TRP to the LMF by including the information in a DL PRS Activation Response message that is an NRPPa message. The DL PRS Activation Response message may include information about the activated PRS, activation indicators, etc.

The LMF may obtain information about activated PRS from TRPs and transmit the obtained information about activated PRS to the UE in the Provide Assistance Data message. At this time, the obtained information about activated PRS may be included in a field for information about activated (on-demand) DL PRS, which is separate from PRS information included in legacy assistance information, and transmitted to the UE.

Then, the LMF may indicate a method to be used for measurement to the UE via a Request Location Information message. Upon receiving the Request Location Information message, the UE may measure PRS by using the obtained information about activated DL PRS, perform the measurement by using the indicated method, and transmit the result to the LMF.

The LMF may make a determination based on the transmitted result, and turn off, i.e., deactivate, DL PRS that is considered no longer necessary. To this end, information about DL PRS requiring turning-off and a turn-off indicator may be included in the NRPPa DL PRS Activation Request message and transmitted to the TRP. Upon receiving the PRS Activation Request message, the TRP may turn off the indicated DL PRS and inform the LMF of information about the turned-off DL PRS.

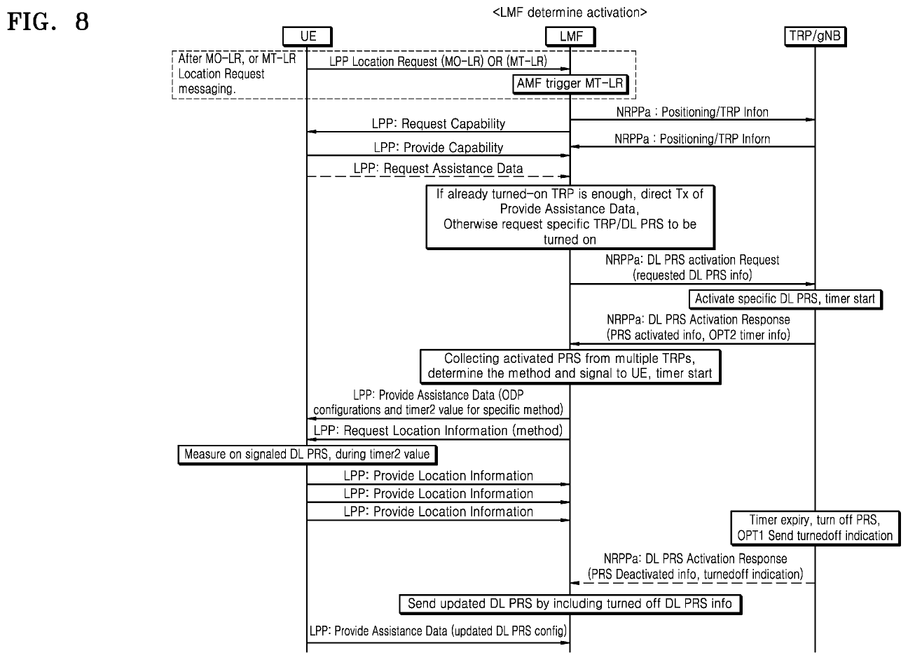

FIG. 8 is a diagram for describing a method of notifying a UE of validity time information when a validity time of activated DL PRS exists, according to an embodiment of the present disclosure.

The LMF may receive a LR (MO-LR or MT-LR) from a UE or AMF. Upon receiving the LR, the LMF may perform a positioning operation. Before or after receiving the LR, the LMF may obtain PRS transmission information of each TRP from TRPs existing within its own area or from base stations, e.g., gNBs, serving TRPs, and may be aware of whether each DL PRS is currently being transmitted.

As such, among NRPPa messages used for requesting PRS transmission, an NRPPa Positioning/TRP Information Request message may include an indicator used by the LMF to check whether DL PRS from a corresponding TRP can be turned on or off, an indicator for determining at what level DL PRS can be turned on/off, etc. In addition, an NRPPa Positioning/TRP Information Response message as a response corresponding to the NRPPa Positioning/TRP Information Request message may include an indicator indicating whether DL PRS from the TRP can be turned on/off, an indicator indicating at which level DL PRS can be turned on/off, etc. The indicator indicating a level may specify and deliver a resource unit. For example, the indicator indicating a level may include an indicator indicating a resource level or a resource set level, a frequency level, a cell level, a TRP level, or the like.

The LMF that has received a response to the NRPPa Positioning/TRP Information Request from the TRP may indicate DL PRS in resource units indicated as available when later requesting on-demand DL PRS transmission from a specific TRP.

The LMF may request capability information from the UE that has transmitted the LR, receive a response thereto, and store the capability information of the UE. If the LMF determines, based on the PRS transmission information of each TRP and the capability information of the UE, that pieces of information about currently activated DL PRSs are sufficient to measure a location of the UE, the LMF may immediately transmit the pieces of information about DL PRSs that are currently in use to the UE via the LPP Provide Assistance Data. In an embodiment, the LMF may determine whether pieces of information about currently activated DL PRSs are sufficient to measure the location of the UE, based on the number of the currently activated DL PRSs, a relative location, transmission power, etc. If the LMF determines that current PRSs are not sufficient and there is a TRP additionally available for activation, the LMF may request additional activation of DL PRS from the TRP via an NRPPa message.

In this process, a DL PRS Activation Request message that is the NRPPa message may be used. The DL PRS Activation Request message may include the aforementioned pieces of information related to a PRS whose activation is to be requested, such as cell, frequency, resource set, resource, beam, etc. Upon receiving the DL PRS Activation Request message, the TRP may activate the PRS by considering the requested PRS resources. The TRP may finally transmit information about the PRS activated by the TRP to the LMF by including the information in a DL PRS Activation Response message that is an NRPPa message. The DL PRS Activation Response message may include information about the activated PRS, activation indicators, etc. The DL PRS Activation Response message may also include validity time information for activation by the TRP.

The LMF may obtain information about activated PRS from TRPs and transmit the obtained information about activated PRS to the UE in the Provide Assistance Data message. At this time, the obtained information about activated PRS may be included in a field for information about activated (on-demand) DL PRS, which is separate from PRS information included in the legacy assistance information, and transmitted to the UE. In addition, if the LMF obtains activation validity time of PRS from each TRP, the LMF may configure a validity time of on-demand PRS, which is transmitted via assistance data, by considering the activation validity time received from each TRP, and transmit the configured validity time to the UE.

Thereafter, the LMF may indicate a method to be used for measurement to the UE via a Request Location Information message. Upon receiving the Request Location Information message, the UE may measure PRS by using the obtained information about activated DL PRS, perform the measurement by using the indicated method, and transmit the result to the LMF. In addition, if the validity time of the activated PRS is configured for the UE, the UE may perform necessary DL PRS measurements during the validity time and additionally transmit the measurement results to the LMF several times.

The LMF may make a determination based on the transmitted results, and turn off, i.e., deactivate, DL PRS that is considered no longer necessary. To this end, information about DL PRS requiring turning-off and a turn-off indicator may be included in the NRPPa DL PRS Activation Request message and transmitted to the TRP. Upon receiving the PRS Activation Request message, the TRP may turn off the indicated DL PRS and inform the LMF of information about the turned-off DL PRS.

As described above, the LMF may inform the UE of a timer value, or the TRP may deactivate the activated PRS on its own after a specific time elapses and notify the LMF of the corresponding information. In this case, the NRPPa DL PRS Activation Response message may be used, and include information about the deactivated PRS, a turn-off indicator, etc.

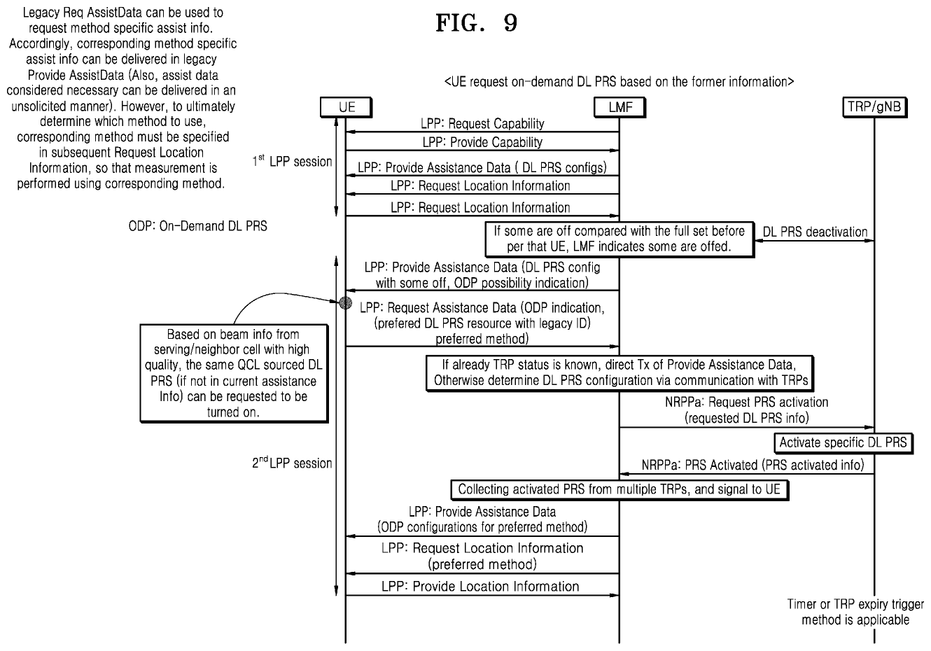

FIG. 9 is a diagram for describing a method, performed by a UE, of requesting on-demand PRS, according to an embodiment of the present disclosure.

If the UE has already performed measurement based on assistance information during a previous first LPP session, and then some PRSs used for the measurement are turned off, the LMF may recognize the corresponding information. When newly starting a second LPP session, the LMF may transmit an indicator indicating that some of the PRSs previously used for measurement are turned off and there are DL PRS that can be additionally turned on to the UE that operated the first LPP session by including the indicator in a Provide Assistance Data message associated with the second LPP session.

In an embodiment, the LMF may transmit configuration information for a PRS that can be turned on or off to the UE, along with the indicator. In this case, the configuration information may include DL PRS configuration information that can be transmitted from each TRP when DL PRS is turned on or off. Also, the configuration information may include a combination of TRPs and/or a combination of configuration information for DL PRSs transmitted from TRPs. In this case, the configuration information may include a configuration ID value related to the combination of TRPs and/or the combination of configuration information for DL PRSs transmitted from TRPs (e.g., a DL PRS set in a cross TRP).

Upon receiving the Provide Assistance Data message, the UE checks a turned-off PRS based on DL PRSs previously used for measurement, and if the UE determines that a PRS is additionally necessary, the UE transmits required PRS information in a Request Assistance Data message to the LMF.

Thereafter, a process in which the LMF requests activation from each TRP and transmits a result of the request to the UE as assistance data information, and then the UE performs measurement and reports the result to the LMF is the same as operations of FIGS. 7 and 8.

Even if the UE can request on-demand DL PRS transmission, extremely frequent requests from the UE may cause performance degradation due to signal overload in LMF operation and network operation. Therefore, in an embodiment, a method of preventing too frequent requests from the UE via a timer may be used. A timer value of this timer may be determined by the LMF and delivered to the UE via an LPP Provide Assistance Data message or a DL LPP or DL RRC message corresponding thereto. Upon receiving information including the timer value, the UE may check whether the timer is running based on the received timer value when it wants to request on-demand DL PRS transmission thereafter. If the timer is running based on the currently received timer value, the UE cannot deliver on-demand DL PRS transmission request information to the LMF until the timer expires. If the timer is not running based on the currently received timer value, or if the timer has expired, the UE may deliver its desired on-demand DL PRS transmission request information to the LMF. In addition, the UE may start the timer based on the received timer value.

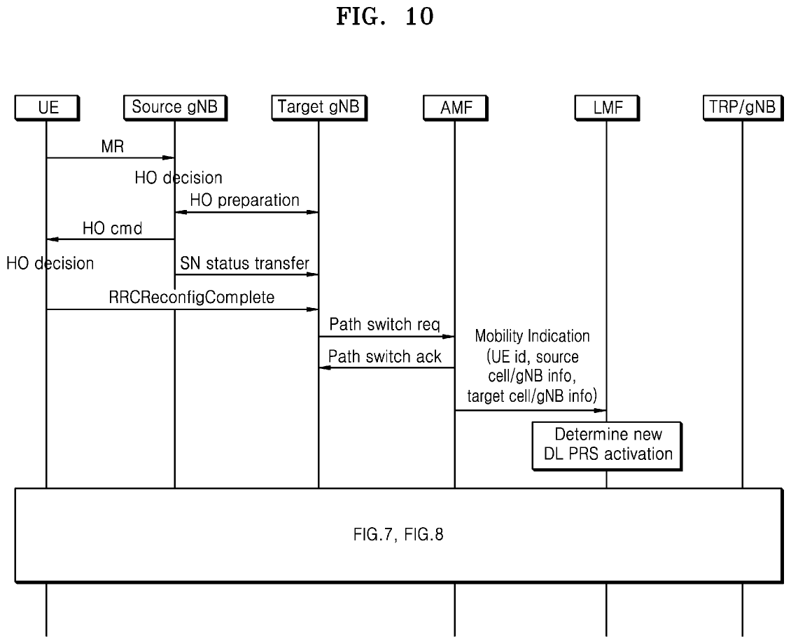

FIG. 10 is a diagram for describing a situation in which an LMF activates on-demand DL PRS according to movement of a UE, according to an embodiment of the present disclosure.

Referring to FIG. 10, a handover may occur when the UE is in an LPP session and is performing measurement after receiving assistance information from a source cell. In this case, after the UE completes movement from a source cell to a target cell, the target cell transmits a path switch request message to an AMF, and the AMF transmits a path switch acknowledgement (ACK), the AMF may transmit to the LMF a message including information indicating that the movement has occurred during the LPP session or during the measurement. The corresponding message may include an ID of the moving UE, cell PCI and CGI information of a source gNB and a target gNB, and ID information of an LPP session being performed by the UE, which can be distinguished by the AMF and LMF. Upon receiving this information, the LMF may determine that a PRS is additionally necessary based on the current target cell and perform an operation of activating a specific PRS that is not currently activated. Subsequent operations are the same as those of FIGS. 7 and 8.

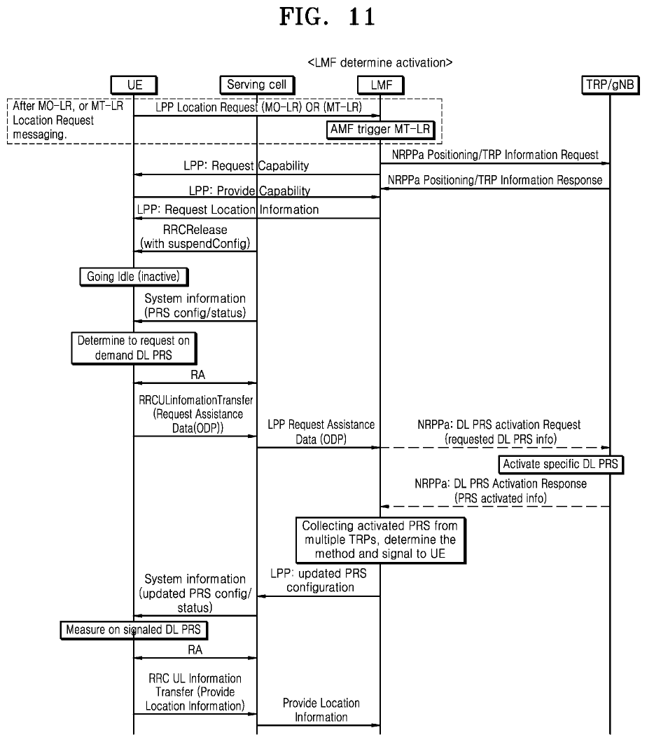

FIG. 11 is a diagram for describing a situation in which a UE in an idle/inactive state requests on-demand PRS when performing measurement, according to an embodiment of the present disclosure.

The LMF may receive a location request (LR)(MO-LR or MT-LR) from a UE or AMF. Upon receiving the LR, the LMF may perform a positioning operation. Before or after receiving the LR, the LMF may obtain PRS transmission information of each TRP from TRPs existing within its own area or from base stations, e.g., gNBs, serving TRPs, and thus, may be aware of whether each DL PRS is currently being transmitted.

As such, among NRPPa messages used for requesting PRS transmission, an NRPPa Positioning/TRP Information Request message may include an indicator used by the LMF to check whether DL PRS from a corresponding TRP can be turned on or off, an indicator for determining at what level DL PRS can be turned on/off, etc. In addition, an NRPPa Positioning/TRP Information Response message as a response corresponding to the NRPPa Positioning/TRP Information Request message may include an indicator indicating whether DL PRS from the TRP can be turned on/off, an indicator indicating at which level DL PRS can be turned on/off, etc. The indicator indicating a level may specify and deliver a resource unit. For example, the indicator indicating a level may include an indicator indicating a resource level or a resource set level, a frequency level, a cell level, a TRP level, etc.

The LMF that has received the response to the NRPPa Positioning/TRP Information Request from the TRP may indicate DL PRS in resource units indicated as available when later requesting on-demand DL PRS transmission from a specific TRP.

The LMF may request capability information from the UE that has transmitted the LR, receive a response thereto, and store the capability information of the UE. In addition, the LMF may transmit to the corresponding target UE a command to perform a positioning measurement operation by delivering an LPP Request Location Information message thereto.

If the UE receiving the command to perform the positioning measurement operation does not have previously stored DL PRS assistance information, or if it has received an LPP Provide Assistance Data message before receiving the Request Location Information message, the UE may perform the positioning measurement operation by using DL PRS information stored or received via the message.

However, the UE may transition to an idle mode by receiving an RRCRelease message from a serving base station during the measurement, or transition to an inactive mode by receiving an RRCRelease with suspendConfig message. In this case, if assistance information for DL PRS is being transmitted from the serving base station in system information block (SIB) X again, measurement may be performed based on DL PRS updated with information in the corresponding SIB X.

The base station may transmit SIB X including information about a PRS currently being operated by the LMF based on the corresponding base station. In this case, the information about the PRS may have the same structure as PRS configuration information in the Provide Assistance Data. In addition, an on/off indicator indicating whether PRS transmission is currently in progress may be added for each PRS resource or resource set, or for each frequency or TRP.

If a UE in an idle/inactive state obtains this PRS information, and if the UE initiates an LPP session in a connected state and needs to perform measurement in an idle/inactive state, the UE performs the measurement based on the DL PRS information updated in the SIB X. In this case, on-demand DL PRS may be requested according to the needs of the UE. That is, the UE may include in an LPP Request Assistance Data message an indicator indicating a request for on-demand PRS and information necessary to indicate the PRS, encapsulate the LPP Request Assistance Data message in an RRCULInformationTransfer message, and transmit, to the base station, the RRCULInformation Transfer message in a UL grant obtained after performing random access (RA).

In this case, a RA preamble or resource may have a dedicated configuration for transmission of a UL message for positioning, and information related to the dedicated configuration may be transmitted via SIB1. In this way, when transmitting in a UL grant, if a message size is large, the UE may additionally perform segmentation of a UL RRC message to deliver it to the serving base station.

Upon receiving the request for on-demand PRS from the UE, in the same manner as in FIGS. 7 and 8, the LMF may request activation from a TRP and transmit, as a result of the request, updated information about the PRS including information about the activated PRS (on/off status of the activated PRS) to the serving base station via the AMF by including the updated information in an LPP message. The serving base station may broadcast the updated information about the PRS as system information, i.e., in SIB X.

The UE receiving this system information measures the corresponding updated PRS, and if necessary, encapsulates LPP Provide Location Information including a measurement result in an RRC UL Information Transfer message, and transmits, in a UL grant obtained via RA, the RRC UL Information Transfer message to the base station if necessary. The base station delivers the LPP message included in the RRC UL Information Transfer message to the LMF via the AMF.

In the above communication between the serving gNB and the LMF, the serving gNB may decode received messages up to the LPP message, add it to a message for a communication interface with the AMF, and transmits the message, and the AMF may transmit the LPP message to the LMF by using the message for the communication interface between the AMF and the LMF.

The methods according to the embodiments described in the appended claims or specification of the present disclosure may be implemented in hardware, software, or a combination of hardware and software.

When the methods are implemented in software, a computer-readable storage medium having at least one program (software module) stored therein may be provided. The at least one program stored in the computer-readable storage medium is configured for execution by at least one processor within an electronic device. The at least one program includes instructions that cause the electronic device to execute the methods according to the embodiments described in the claims or specification of the present disclosure.

The program (software module or software) may be stored in random access memory (RAM), non-volatile memory including a flash memory, read-only memory (ROM), electrically erasable programmable ROM (EEPROM), magnetic disc storage devices, compact disc (CD)-ROM, digital versatile discs (DVDs) or other types of optical storage devices, and magnetic cassettes. Alternatively, the program may be stored in a memory that is configured as a combination of some or all of the stated devices. A plurality of such devices may be included in the memory.

Furthermore, the program may be stored in an attachable storage device that may be accessed through communication networks, such as the Internet, Intranet, a LAN, a WLAN, and a storage area network (SAN), or a communication network configured in a combination thereof. The storage device may connect to a device for performing a method according to an embodiment of the present disclosure via an external port. Furthermore, a separate storage device on a communication network may also connect to a device for performing a method according to an embodiment of the present disclosure.

Moreover, in the drawings illustrating the methods of the present disclosure, the order of description does not necessarily correspond to the order of execution, and the methods may be performed in a reverse order or executed in parallel.

Alternatively, the drawings illustrating the methods of the present disclosure may not include some elements and may include only some elements without impairing the essence of the present disclosure.

Furthermore, the methods of the present disclosure may be carried out in combination of some or all of the contents included in each embodiment within the scope not departing from the essence of the disclosure.

Moreover, the embodiments of the present disclosure described in the present specification and the drawings is provided for illustration purpose only to easily describe the technical idea of the present disclosure and assist in understanding the present disclosure and not for the purpose of limiting the scope of the present disclosure. In other words, it is obvious to those of ordinary skill in the art that other modifications may be made based on the technical spirit of the present disclosure. Furthermore, the embodiments may be combined with each other for operation when necessary.

A method performed by an LMF in a wireless communication system, according to an embodiment of the present disclosure, may include obtaining DL PRS configuration information, determining, at least based on the obtained DL PRS configuration information, a need for on-demand DL PRS configuration information, and, if it is determined that the on-demand DL PRS configuration information is needed, transmitting the on-demand DL PRS configuration information to a UE.

According to an embodiment, the method may further include requesting the on-demand DL PRS configuration information from a TRP if it is determined that the on-demand DL PRS configuration information is needed, and receiving the on-demand DL PRS configuration information from the TRP. In an embodiment, the requesting and the receiving of the on-demand DL PRS configuration information may be performed via an NRPPa message.

According to an embodiment, the method may further include transmitting the DL PRS configuration information to the UE if it is determined that the on-demand DL PRS configuration information is not needed.

According to an embodiment, the method may further include transmitting the DL PRS configuration information to the UE, receiving a request for the on-demand DL PRS configuration information from the UE, and determining, based on the request for the on-demand DL PRS configuration information and the obtained DL PRS configuration information, a need for the on-demand DL PRS configuration information.

According to an embodiment, the request for the on-demand DL PRS configuration information may be received via an LPP Request Assistance Data message.

According to an embodiment, the DL PRS configuration information may include IDs of available DL PRS parameters.

An LMF communicating with a UE in a wireless communication system, according to an embodiment of the present disclosure, may include a transceiver, and a processor operatively coupled to the transceiver and configured to obtain DL PRS configuration information, determine, at least based on the obtained DL PRS configuration information, a need for on-demand DL PRS configuration information, and, if it is determined that the on-demand DL PRS configuration information is needed, transmit the on-demand DL PRS configuration information to the UE.

According to an embodiment, the method may further include requesting the on-demand DL PRS configuration information from a TRP if it is determined that the on-demand DL PRS configuration information is needed, and receiving the on-demand DL PRS configuration information from the TRP. In an embodiment, the requesting and the receiving of the on-demand DL PRS configuration information may be performed via an NRPPa message.

According to an embodiment, the method may further include transmitting the DL PRS configuration information to the UE if it is determined that the on-demand DL PRS configuration information is not needed.

According to an embodiment, the method may further include transmitting the DL PRS configuration information to the UE, receiving a request for the on-demand DL PRS configuration information from the UE, and determining, based on the request for the on-demand DL PRS configuration information and the obtained DL PRS configuration information, a need for the on-demand DL PRS configuration information.

According to an embodiment, the request for the on-demand DL PRS configuration information may be received via an LPP Request Assistance Data message.

According to an embodiment, the DL PRS configuration information may include IDs of available DL PRS parameters.

A method performed by a UE in a wireless communication system, according to an embodiment of the present disclosure, may include receiving DL PRS configuration information from an LMF, transmitting, based on the received DL PRS configuration information, a request for on-demand DL PRS configuration information to the LMF, and receiving the on-demand DL PRS configuration information from the LMF if it is determined by the LMF, based on the request for the on-demand DL PRS configuration information and the DL PRS configuration information, that the on-demand DL PRS configuration information is needed.

1. A method performed by a location management function (LMF) in a wireless communication system, the method comprising:
obtaining downlink positioning reference signal (DL PRS) configuration information;
determining, at least based on the obtained DL PRS configuration information, a need for on-demand DL PRS configuration information; and
in case that it is determined that the on-demand DL PRS configuration information is needed, transmitting, to a user equipment (UE), the on-demand DL PRS configuration information.

2. The method of claim 1, further comprising:
requesting the on-demand DL PRS configuration information from a transmission and reception point (TRP) in case that it is determined that the on-demand DL PRS configuration information is needed; and
receiving, from the TRP, the on-demand DL PRS configuration information.

3. The method of claim 2, wherein the requesting and the receiving of the on-demand DL PRS configuration information are performed via a new radio positioning protocol A (NRPPa) message.

4. The method of claim 1, further comprising transmitting, to the UE, the DL PRS configuration information in case that it is determined that the on-demand DL PRS configuration information is not needed.

5. The method of claim 1, further comprising:
transmitting, to the UE, the DL PRS configuration information;
receiving, from the UE, a request for the on-demand DL PRS configuration information; and
determining, based on the request for the on-demand DL PRS configuration information and the obtained DL PRS configuration information, a need for the on-demand DL PRS configuration information.

6. The method of claim 1, wherein the request for the on-demand DL PRS configuration information is received via a long-term evolution (LTE) positioning protocol (LPP) Request Assistance Data message.

7. The method of claim 1, wherein the DL PRS configuration information comprises identities (IDs) of available DL PRS parameters.

8. A location management function (LMF) communicating a user equipment (UE) in a wireless communication system, the LMF comprising:
a transceiver; and
a processor operatively coupled to the transceiver and configured to
obtain downlink positioning reference signal (DL PRS) configuration information,
determine, at least based on the obtained DL PRS configuration information, a need for on-demand DL PRS configuration information, and
in case that it is determined that the on-demand DL PRS configuration information is needed, transmit, to the UE, the on-demand DL PRS configuration information.

9. The LMF of claim 8, wherein the processor is further configured to
request the on-demand DL PRS configuration information from a transmission and reception point (TRP) in case that it is determined that the on-demand DL PRS configuration information is needed, and
receive, from the TRP, the on-demand DL PRS configuration information.

10. The LMF of claim 9, wherein the requesting and the receiving of the on-demand DL PRS configuration information are performed via a new radio positioning protocol A (NRPPa) message.

11. The LMF of claim 8, wherein the processor is further configured to transmit, to the UE, the DL PRS configuration information in case that it is determined that the on-demand DL PRS configuration information is not needed.

12. The LMF of claim 8, wherein the processor is further configured to
transmit, to the UE, the DL PRS configuration information,
receive, from the UE, a request for the on-demand DL PRS configuration information, and
determine, based on the request for the on-demand DL PRS configuration information and the obtained DL PRS configuration information, a need for the on-demand DL PRS configuration information.

13. The LMF of claim 8, wherein the request for the on-demand DL PRS configuration information is received via a long-term evolution (LTE) positioning protocol (LPP) Request Assistance Data message.

14. The LMF of claim 8, wherein the DL PRS configuration information comprises identities (IDs) of available DL PRS parameters.

15. A method performed by a user equipment (UE) in a wireless communication system, the method comprising:
receiving downlink positioning reference signal (DL PRS) configuration information from a location management function (LMF);
transmitting, based on the received DL PRS configuration information, a request for on-demand DL PRS configuration information to the LMF; and
receiving, from the LMF, the on-demand DL PRS configuration information in case that it is determined by the LMF, based on the request for the on-demand DL PRS configuration information and the DL PRS configuration information, that the on-demand DL PRS configuration information is needed.
